(19) United States
(12) Patent Application Publication
(10) Pub. No.: US 2025/0272580 A1
(43) Pub. Date: Aug. 28, 2025

(54) SYSTEM AND METHOD FOR PARALLEL PROCESSING OF A DECISION TREE

(71) Applicant: UNTETHER AI CORPORATION, Toronto (CA)

(72) Inventors: Ofer Shai, North York (CA); John S. Kitamura, Toronto (CA)

(21) Appl. No.: 18/590,064

(22) Filed: Feb. 28, 2024

(51) Int. Cl. G06N 5/02

(52) U.S. Cl. CPC G06N 5/02

(57) ABSTRACT

An example computing device includes: a bank of processing elements; and a controller configured to: obtain an input vector having a plurality of input attributes, the input vector to be processed by a decision tree to identify a determined outcome; control the bank of processing elements to process the input vector to obtain a result vector, wherein each input attribute is processed by one of the processing elements in the bank to obtain a result, and wherein the result vector comprises a combination of the results; control the bank of processing elements to accumulate the result vector with an outcome vector for each potential outcome of the decision tree to obtain a respective outcome metric for each potential outcome; and select one potential outcome as the determined outcome of the decision tree for the input vector based on the respective outcome metrics for each potential outcome.

### FIELD

The specification relates generally to processing decision trees to determine an outcome of the decision tree, and more particularly to a system and method for parallel processing of a decision tree.

### BACKGROUND

Decision trees may be used in many industries to select different outcomes from a plurality of potential outcomes based on a series of individual determinations based on a respective series of attributes at different nodes of the decision tree. The nodes of the decision tree are processed hierarchically, with given nodes being processed based on the results from an earlier level node. The sequential and hierarchical nature of decision trees results in slow and inefficient processing.

### SUMMARY

According to an aspect of the present specification an example computing device includes: a bank of processing elements; a controller interconnected with the bank of processing elements, the controller configured to: obtain an input vector having a plurality of input attributes, the input vector to be processed by a decision tree to identify a determined outcome for the input vector; control the bank of processing elements to process the input vector to obtain a result vector, wherein each input attribute is processed by one of the processing elements in the bank to obtain a result, and wherein the result vector comprises a combination of the results; control the bank of processing elements to accumulate the result vector with an outcome vector for each potential outcome of the decision tree to obtain a respective outcome metric for each potential outcome; and select one potential outcome as the determined outcome of the decision tree for the input vector based on the respective outcome metrics for each potential outcome.

According to another aspect of the present specification, an example method includes: obtaining an input vector having a plurality of input attributes, the input vector to be processed by a decision tree to identify a determined outcome for the input vector; controlling a bank of processing elements to process the input vector to obtain a result vector, wherein each input attribute is processed by one of the processing elements in the bank to obtain a result, and wherein the result vector comprises a combination of the results; controlling the bank of processing elements to accumulate the result vector with an outcome vector for each potential outcome of the decision tree to obtain a respective outcome metric for each potential outcome; and selecting one potential outcome as the determined outcome of the decision tree for the input vector based on the respective outcome metrics for each potential outcome.

### BRIEF DESCRIPTION OF DRAWINGS

Implementations are described with reference to the following figures, in which:

FIG. 1 depicts a schematic block diagram of an example computing device configured processing a decision tree in a parallel operation.

FIG. 2 depicts a schematic block diagram of a row of processing elements of the computing device of FIG. 1.

FIGS. 3A and 3B depict schematic diagrams of a matrix-vector multiplication and memory loading and processing of the matrix-vector multiplication in an array of processing elements of the computing device of FIG. 1.

FIG. 4 depicts a schematic diagram of an example decision tree for processing by the computing device of FIG. 1.

FIG. 5 depicts a flowchart of an example method of processing a decision tree in a parallel operation.

FIG. 6 depicts a flowchart of an example method of initializing a set of processing elements during the method of FIG. 5.

FIG. 7 depicts a schematic diagram of an example initialization state of a set of processing elements of the computing device of FIG. 1 during block 505 of the method of FIG. 5.

FIGS. 8A and 8B depict schematic diagrams of further example states of the set of processing elements of the computing device of FIG. 1 during blocks 510 and 515 of the method of FIG. 5.

FIG. 9 depicts a flowchart of an example method of identifying a determined outcome during the method of FIG. 5.

### DETAILED DESCRIPTION

Decision trees are typically processed sequentially, with certain nodes being processed based on the results of earlier level nodes, resulting in slow and inefficient processing. In particular, in a distributed parallel computing device, the sequential processing can be difficult to manage based on memory and time requirements to store results from earlier level nodes.

Accordingly, the present exemplary computing device includes a distributed parallel computing system which is configured to process the decision tree on a given input vector with a corresponding distributed parallel processing method. In particular, the computing device may, in a first phase, perform a node comparison operation for the given input vector, wherein each node is processed by one processing element of a bank of processing elements. In particular, each node of the decision tree is processed in parallel, irrespective of the level on which the node resides, or results from earlier level nodes. In a second phase, the result vector from the node comparison operation is accumulated with each outcome vector representing each potential outcome to obtain respective outcome metrics for each potential outcome. In particular, the accumulation of the outcome metrics of the potential outcomes may similarly be performed in parallel, for example using a generalized matrix-vector multiplication in the distributed parallel computing system. The outcome metrics may then be assessed (e.g., including further manipulations and/or normalization) to identify one of the potential outcomes as the determined outcome for the given input vector.

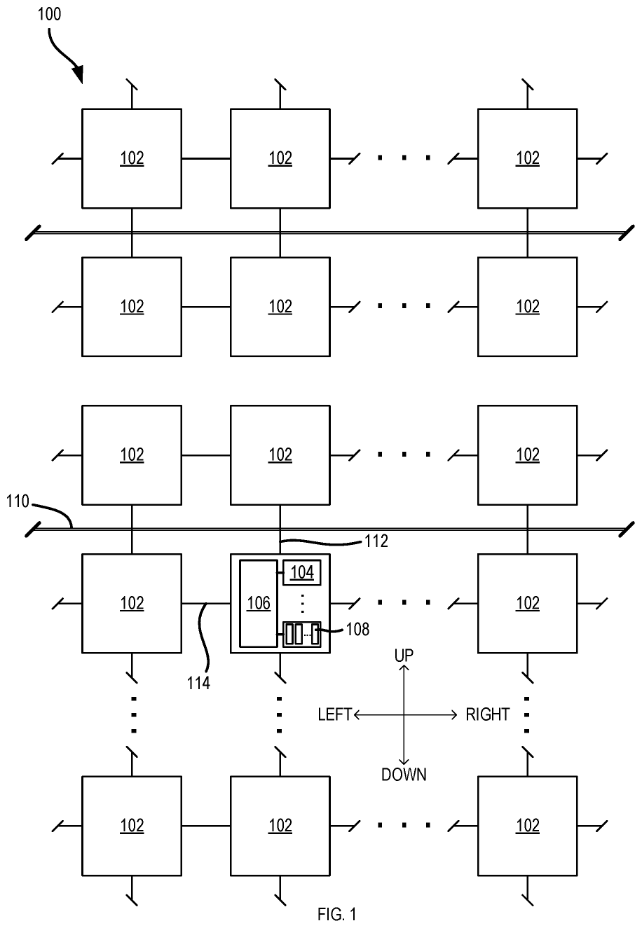

FIG. 1 shows such an example a computing device 100. The computing device 100 includes a plurality of banks 102 of processing elements. The banks 102 may be operated in a cooperative manner to implement a parallel processing scheme, such as a SIMD scheme.

The banks 102 may be arranged in a regular rectangular grid-like pattern, as illustrated. For sake of explanation, relative directions mentioned herein will be referred to as up, down, vertical, left, right, horizontal, and so on. However, it is understood that such directions are approximations, are not based on any particular reference direction, and are not to be considered limiting. Any practical number of banks 102 may be used. Limitations in semiconductor fabrication techniques may govern. In some examples, 512 banks 102 are arranged in a 32-by-16 grid.

A bank 102 may include a plurality of rows 104 of processing elements (PEs) 108 and a controller 106. A bank 102 may include any practical number of PE rows 104. For example, eight rows 104 may be provided for each controller 106. In some examples, all banks 102 may be provided with the same or similar arrangement of rows. In other examples, substantially all banks 102 are substantially identical. In still other examples, a bank 102 may be assigned a special purpose in the computing device and may have a different architecture, which may omit PE rows 104 and/or a controller 106. Any practical number of PEs 108 may be provided to a row 104. For example, 256 PEs may be provided to each row 104. Continuing the numerical example above, 256 PEs provided to each of eight rows 104 of 512 banks 102 means the computing device 100 includes about 1.05 million PEs 108, less any losses due to imperfect semiconductor manufacturing yield. A PE 108 may be configured to operate at any practical bit size, such as one, two, four, or eight bits. PEs may be operated in pairs to accommodate operations requiring wider bit sizes.

Instructions and/or data may be communicated to/from the banks 102 via an input/output (I/O) bus 110. The I/O bus 110 may include a plurality of segments. A bank 102 may be connected to the I/O bus 110 by a vertical bus 112. Additionally or alternatively, a vertical bus 112 may allow communication among banks 102 in a vertical direction. Such communication may be restricted to immediately vertically adjacent banks 102 or may extend to further banks 102. A bank 102 may be connected to a horizontally neighboring bank 102 by a horizontal bus 114 to allow communication among banks 102 in a horizontal direction. Such communication may be restricted to immediately horizontally adjacent banks 102 or may extend to further banks 102.

Communications through any or all of the busses 110, 112, 114 may include direct memory access (DMA) to memory of the rows 104 of the PEs 108. Additionally or alternatively, such communications may include memory access performed through the processing functionality of the PEs 108.

The computing device 100 may include a main processor (not shown) to communicate instructions and/or data with the banks 102 via the I/O bus 110, manage operations of the banks 102, and/or provide an I/O interface for a user, network, or other device. The I/O bus 110 may include a Peripheral Component Interconnect Express (PCIe) interface or similar.

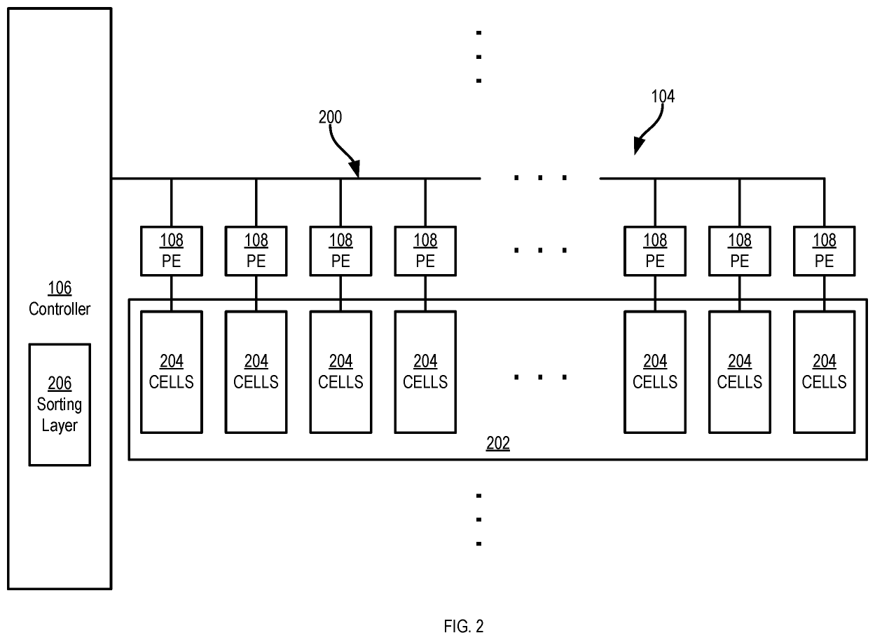

FIG. 2 shows an example row 104 including an array of processing elements 108, which may be physically arranged in a linear pattern (e.g., a physical row). Each PE 108 includes an arithmetic logic unit (ALU) to perform an operation, such as addition, multiplication, and so on. The PEs 108 are mutually connected to share or communicate data. For example, interconnections 200 may be provided among the array of PEs 108 to provide direct communication among neighboring PEs 108. The interconnections 200 among the PEs 108 and with the controller 106 are shown schematically for sake of explanation, however the interconnections 200 may be direct connections between two given PEs 108 (e.g., between a given PE 108 and a neighboring PE 108, an n+1 neighbor PE 108, etc.). The endmost PEs 108 at one end of a row 104 may have connections to a controller 106. Additionally or alternatively, end-most PEs 108 of one bank 102 may connect in the same relative manner through the controller 106 and to PEs 108 of an adjacent bank 102. That is, the controller 106 may be connected between two rows 104 of PEs 108 in adjacent banks 102. In other examples, a set of interconnections 200 may be provided to connect PEs 108 in up-down (column-based) connections, so that information may be shared directly between PEs 108 that are in adjacent rows.

A row 104 of PEs 108 may include memory 202 to store data for the row 104. A PE 108 may have a dedicated space in the memory 202. For example, each PE 108 may be connected to a different range of memory cells 204. Any practical number of memory cells 204 may be used. In one example, 144 memory cells 204 are provided to each PE 108.

The controller 106 may control the array of PEs 108 to perform a SIMD operation with data in the memory 202. For example, the controller 106 may trigger the PEs 108 to simultaneously add two numbers stored in respective cells 204.

The controller 106 may communicate data to and from the memory 202 though the PEs 108. For example, the controller 106 may load data into the memory 202 by directly loading data into connected PEs 108 and controlling PEs 108 to shift the data to PEs 108 further in the array. PEs 108 may load such data into their respective memory cells 204. For example, data destined for rightmost PEs 108 may first be loaded into leftmost PEs and then communicated rightwards by interconnections 200 before being stored in rightmost memory cells 204. Other methods of I/O with the memory, such as direct memory access by the controller 106, are also contemplated. The memory cells 204 of different PEs 108 may have the same addresses, so that address decoding may be avoided to the extent possible.

Data stored in memory cells 204 may be any suitable data, such as operands, operators, coefficients, vector components, and similar. In particular, the controller 106 may include a sorting layer 206 configured to select features to be assigned to the row 104 of PEs 108 and to subsequently load suitable operands, operators, coefficients, vector components, and other data to the memory cells 204 according to the selected features and the order in which features are assigned to the PEs 108 as will be further described herein.

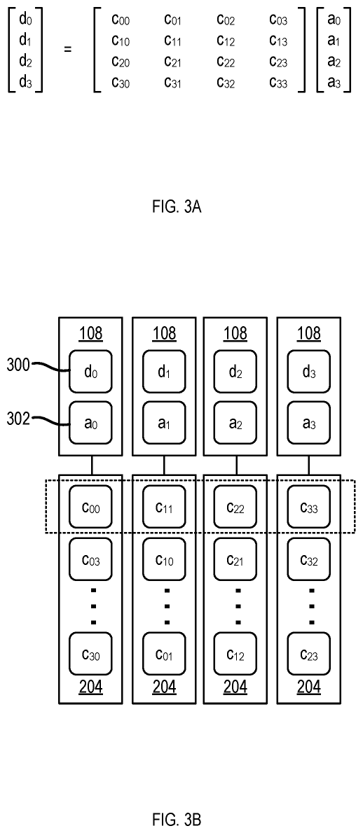

FIG. 3A shows an example matrix multiplication to be processed by the PEs 108. A matrix multiplication may be a generalized matrix-vector multiply (GEMV). A matrix multiplication may use a coefficient matrix and an input vector to obtain a resultant vector. In this example, the coefficient matrix is a four-by-four matrix and the vectors are of length four. In other examples, matrices and vectors of any practical size may be used. In other examples, a matrix multiplication may be a generalized matrix-matrix multiply (GEMM).

FIG. 3B illustrates an array of PEs 108 and related memory cells 204 for carrying out the matrix multiplication illustrated in FIG. 3A. Each PE 108 may include local registers 300, 302 to hold data undergoing an operation. Memory cells 204 may also hold data contributing to the operation.

As matrix multiplication involves sums of products, the PEs 108 may additively accumulate resultant vector components d₀ to d₃ in respective registers 300, while input vector components a₀ to a₃ are multiplied by respective coefficients c₀₀ to c₃₃. That is, one PE 108 may accumulate a resultant vector component d₀, a neighbor PE 108 may accumulate another resultant vector component d₁, and so on. Resultant vector components d₀ to d₃ may be considered dot products. Generally, a GEMV may be considered a collection of dot products of a vector with a set of vectors represented by the rows of a matrix.

To facilitate matrix multiplication, the contents of registers 300 and/or registers 302 may be rearranged among the PEs 108. In this example, resultant vector components d₀ to d₃ remain fixed and input vector components a₀ to a₃ are moved. Further, coefficients coo to c₃₃ may be loaded into memory cells to optimize memory accesses.

In the example illustrated in FIGS. 3A and 3B, the input vector components a₀ to a₃ are loaded into a sequence of PEs 108 that are to accumulate resultant vector components d₀ to d₃ in the same sequence. The relevant coefficients c₀₀, c₁₁, c₂₂, c₃₃ are accessed and multiplied by the respective input vector components a₀ to a₃. That is, a₀ and c₀₀ are multiplied and then accumulated as d₀, a₁ and c₁₁ are multiplied and then accumulated as d₁, and so on.

The input vector components a₀ to a₃ are then rearranged so that a remaining contribution of each input vector components a₀ to a₃ to a respective resultant vector components d₀ to d₃ may be accumulated.

For example, input vector components a₀ to a₂ are moved one PE 108 to the right and input vector components as is moved three PEs 108 to the left. The result is that a next arrangement of input vector components a₃, a₀, a₁, a₂ at the PEs 108 is achieved, where each input vector component is located at a PE 108 that it has not yet occupied during the present matrix multiplication. Appropriate coefficients c₀₃, c₁₀, c₂₁, c₃₂ in memory cells 204 are then accessed and multiplied by the respective input vector components a₃, a₀, a₁, a₂. That is, as and cos are multiplied and then accumulated as d₀, a₀ and c₁₀ are multiplied and then accumulated as d₁, and so on.

The input vector components a₀ to a₃ are then rearranged twice more, with multiplying accumulation being performed with the input vector components and appropriate coefficients at each new arrangement. At the conclusion of four sets of multiplying accumulation and three intervening rearrangements, the accumulated resultant vector components d₀ to d₃ represent the final result of the matrix multiplication.

Further, the arrangements of coefficients c₀₀ to c₃₃ in the memory cells 204 may be predetermined, so that each PE 108 may access the next coefficient needed without requiring coefficients to be moved among memory cells 204. The coefficients c₀₀ to c₃₃ may be arranged in the memory cells 204 in a diagonalized manner, such that a first row of coefficients is used for a first arrangement of input vector components, a second row of coefficients is used for a second arrangement of input vector components, and so on.

Hence, the respective memory addresses referenced by the PEs 108 after a rearrangement of input vector components may be incremented or decremented identically. For example, with a first arrangement of input vector components, each PE 108 may reference its respective memory cell at address 0 for the appropriate coefficient. Likewise, with a second arrangement of input vector components, each PE 108 may reference its respective memory cell at address 1 for the appropriate coefficient, and so on.

Accordingly, the computing device 100 is configured for efficient parallel processing, in particular in performing GEMVs using the banks 102 of PEs 108. More particularly, in the present example, the computing device 100 may be applied to process a decision tree to identify a determined outcome from an input vector by organizing and converting the decision tree as a matrix of coefficients. The computing device 100 may then perform a GEMV to obtain the determined outcome using parallel instead of sequential processing, as described further herein.

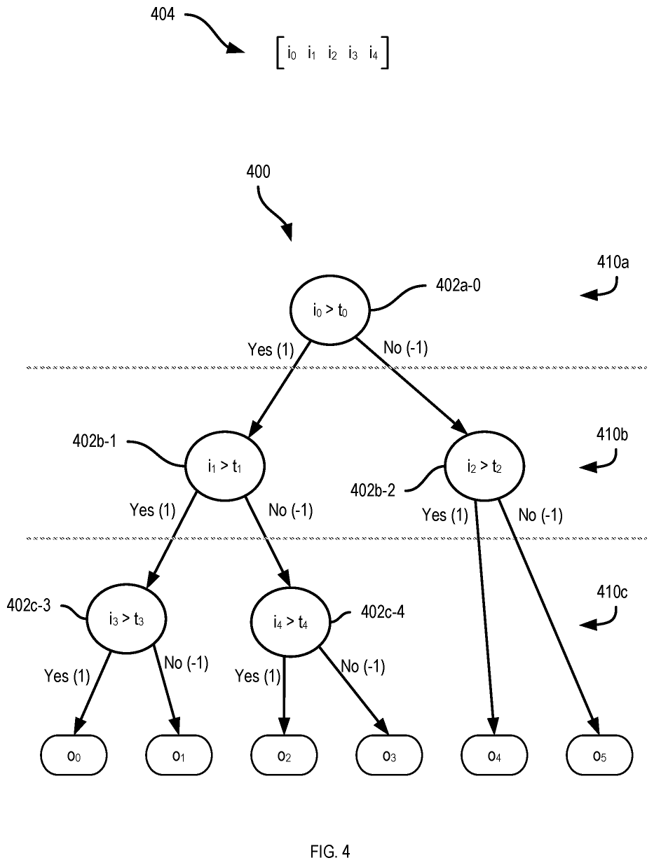

For example, referring to FIG. 4, an example decision tree 400 is depicted. The decision tree 400 includes a plurality of nodes 402; in the present example, five nodes 402a-0, 402b-1, 402b-2, 402c-3, and 402c-4 are depicted (referred to herein generically as a node 402, and collectively as nodes 402; this nomenclature may be used elsewhere herein). In other examples, the decision tree 400 may include more or fewer nodes.

The decision tree 400 is configured to evaluate an input vector 404 having a plurality of input attributes, i₀, i₁, i₂, i₃, and i₄, where each input attribute corresponds to a feature f. To evaluate the input vector 404, each node 402 is configured to compare one of the features f to a threshold value t to determine a result at the given node 402. More particularly, each node 402 is configured to compare a specific input value, or input attribute i for the feature f to the corresponding threshold value t.

Thus, for example, the node 402a-0 is configured to compare the input attribute i₀ for the feature f₀ to a threshold value t₀, the node 402b-1 is configured to compare the input attribute i₁ for the feature f₁ to a threshold value t₁, the node 402b-2 is configured to compare the input attribute i₂ for the feature f₂ to a threshold value t₂, the node 402c-3 is configured to compare the input attribute is for the feature f₃ to a threshold value t₃, and the node 402c-4 is configured to compare the input attribute i₄ for the feature f₄ to a threshold value t₄.

The input vector 404 may therefore have at least as many, and preferably the same number, of input attributes 406 as nodes 402 in the decision tree 400. Thus, in the present example, the input vector 404 has five input attributes; in other examples, the input vector 404 may have more or fewer input attributes.

As a result of evaluating the input attributes of the input vector 404 at at least a subset of the nodes 402, a determined outcome o for the input vector 404 may be determined. For example, the decision tree 400 may have six possible outcomes o₀, o₁, o₂, o₃, o₄, and o₅. Evaluation of the input vector 404 by the decision tree 400 allows a single one of the six possible outcomes to be identified based on the combination of results at the nodes 402.

The decision tree 400 may be applied in healthcare, business, finance, or the like to objectively evaluate cases (e.g., individuals, organizations, etc.) by comparing certain attributes (i.e., the input attributes) of certain features to fixed thresholds at each of the nodes 402. For example, the decision tree 400 may evaluate a person's age (e.g., an input attribute of 46 for a specific person, for ‘age’ as the feature f) to a given age threshold t, a person's income to a given income threshold, etc.

In a typical application, the decision tree 400 may have a number of levels, of which three example levels 410a, 410b, and 410c are depicted, with each level 410x containing corresponding nodes 402x. The decision tree 400 may be evaluated sequentially by level 410, with one node 402 being evaluated in each level 410 of the tree 400. For example, the node 402a-0 may be evaluated first (i.e., at the first level 410a), one of the nodes 402b-1 or 402b-2 may be evaluated next (i.e., at the second level 410b) depending on the result at the first level 410a, and so on. Accordingly, the nodes 402 are evaluated sequentially and selectively, depending on the result at an earlier level node. When the decision tree 400 includes many nodes 402, and in particular, many levels of nodes 402, the evaluation of the decision tree 400 may be slow and consume memory space to track the results at prior nodes as well as input attributes which may or may not be processed at future nodes. In particular, such a sequential and memory-intensive operation may be inefficiently processed on a computing device with distributed, parallel processing, such as the computing device 100.

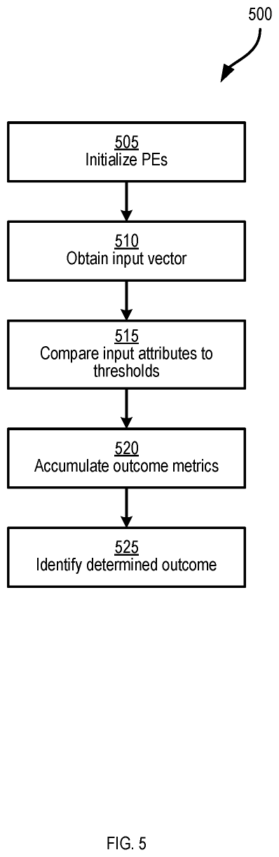

Hence, in accordance with the present disclosure, the decision tree 400 may be parallelized for evaluation by the computing device 100. FIG. 5 depicts a flowchart of an example method 500 of evaluating a decision tree in a parallel operation to identify a determined outcome for a given input. The method 500 will be described in conjunction with its performance by the computing device 100, with reference to the decision tree 400. In other examples, other suitable devices and/or decision trees may be employed. In some examples, some or all of the blocks of the method 500 may be performed in an order other than that depicted, including simultaneous performance of some of the blocks, or similar.

At block 505, the computing device 100 is configured to initialize the bank(s) 102 and/or rows 104 of PEs 108 and the associated memory cells 204 for evaluating an input vector (such as the input vector 404) according to the decision tree 400. In particular, the computing device 100 may load data into the memory cell 204 corresponding to each PE 108 for subsequent node comparison and outcome evaluation operations, as will be described in further detail below. In some examples, the computing device 100 may further load data into the memory cell 204 corresponding to each PE 108 for an outcome selection operation, as described in further detail below. In some examples, a subset of the features or nodes of the decision tree 400 may be selected by the sorting layer 206 for processing by a given bank 102 and/or row 104 of PEs 108.

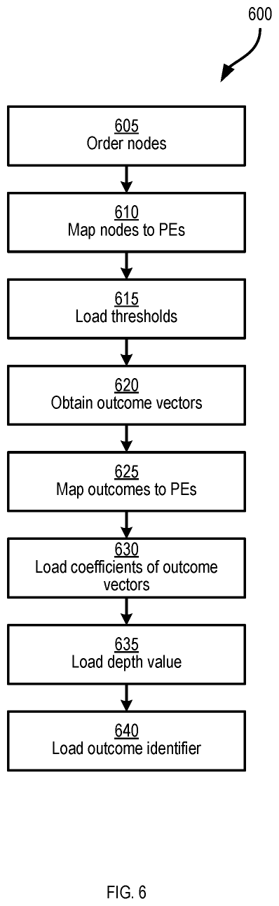

For example, referring to FIG. 6, a flowchart of an example method 600 of initializing the decision tree 400 the computing device 100 is depicted. In particular, the method 600 systematizes the decision tree 400 and structures the computing device 100 to allow the computing device 100 to efficiently evaluate the decision tree 400.

At block 605, the computing device 100 is configured to order the nodes 402 of the decision tree 400. Subsequent operations to evaluate the decision tree 400 may use the nodes to assign various coefficients, thresholds, and/or other data to each of the nodes 402, and accordingly, the computing device 100 may order the nodes 402 to better track the nodes 402. In some examples, the computing device 100 may assign an identifier to each node 402. For example, with reference to the decision tree 400, the computing device 100 may order the nodes 402 as follows: [402a-0, 402b-1, 402b-2, 402c-3, 402c-4].

Ordering the nodes 402 may allow the computing device 100 to treat the nodes 402 substantially equally and in parallel, rather than hierarchically (and therefore sequentially) based on the result from a node in an earlier level 410, as will be described further herein. Thus, in another example, the nodes 402 may be ordered as follows: [402c-3, 402a-0, 402c-4, 402b-2, 402b-1], or any other order (e.g., randomly or systematically ordered) which is fixed after the performance of block 605.

At block 610, the computing device 100 assigns and/or maps each node 402 to one PE 108 for the node comparison operation. That is, the assigned and/or mapped PE 108 represents the node 402 and is configured to perform the comparison of an input attribute to a corresponding threshold value. Thus, the comparison at each node 402 is performed at a separate PE 108 in one or more of the banks 102 and may be computed in parallel.

Accordingly, at block 615, the computing device 100 is configured to load the threshold t for each node 402 into the associated memory cell 204 of the PE 108 configured to evaluate the node 402. In particular, the threshold values t may be stored at the same address in each of the memory cell 204 to allow the node comparison operation to be parallelized across the PEs 108.

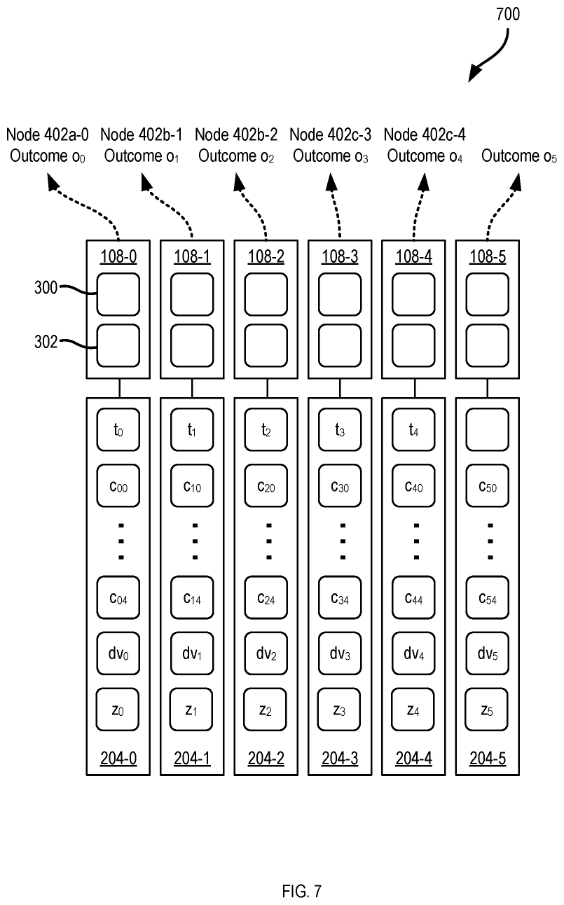

For example, referring to FIG. 7, a partial representation of an array of PEs 108 is depicted. In particular, FIG. 7 depicts an initialization state 700 at initialization of the decision tree 400 to be evaluated by the computing device 100 (e.g., after performance of the method 600). In particular, six PEs 108 are depicted, namely, PEs 108-0, 108-1, 108-2, 108-3, 108-4, and 108-5.

Accordingly, at block 610, the computing device 100 assigns each node 402 to one of the PEs 108. In the present example, the node 402a-0 is assigned to the PE 108-0, the node 402b-1 is assigned to PE 108-1, the node 402b-2 is assigned to the PE 108-2, the node 402c-3 is assigned to the PE 108-3, the node 402c-4 is assigned to the PE 108-4. Since there are fewer nodes 402 than PEs 108, the PE 108-5 may remain unassigned for the node comparison operation.

Subsequently, at block 615, the computing device 100 may load the thresholds t into the corresponding memory cells 204 of the assigned PEs 108. In the present example, the threshold to for the node 402a-0 is loaded into a memory cell 204-0 corresponding to PE 108-0, the threshold t₁ for the node 402b-1 is loaded into a memory cell 204-1 corresponding to PE 108-1, the threshold t₂ for the node 402b-2 is loaded into a memory cell 204-2 corresponding to PE 108-2, the threshold t₃ for the node 402c-3 is loaded into a memory cell 204-3 corresponding to PE 108-3, and the threshold t₄ for the node 402c-4 is loaded into a memory cell 204-4 corresponding to PE 108-4.

Returning to FIG. 6, at block 620, the computing device 100 is configured to obtain outcome vectors for each possible outcome o of the decision tree 400. In particular, each possible outcome o may be represented by a corresponding outcome vector, the components of which represent the result at each node 402 in order to obtain the possible outcome o. The components of the outcome vector may be ordered according to the order of the nodes defined at block 605, such that a given coefficient of each outcome vector represents the different results for each outcome o at the same node 402.

For example, for the first example order of nodes 402 given above, the outcome vectors may be represented by: [c₀₀, cₒ₁, cₒ₂, cₒ₃, cₒ₄], where each Con represents the result at the corresponding node n to obtain a given outcome o. The results (or coefficients) may be represented by a value of 1 if the result at the given node 402 is “Yes” or affirmative (i.e., that the input attribute exceeds the threshold value for the given node 402), a value of −1 if the result at the given node 402 is “No” or negative (i.e., that the input attribute does not exceed the threshold value for the given node 402), and a value of 0 if the result at the given node 402 is immaterial or not evaluated based on the result of another node 402 at an earlier level.

For example, the outcome vector for the outcome o₁ may be given as follows [1, 1, 0, −1, 0]. That is, in order to arrive at the outcome o₁, the result at the node 402a-0 is affirmative (1), the result at the node 402b-1 is affirmative (1), the result at the node 402b-2 is immaterial given the affirmative result at the (earlier) node 402a-0 (0), the result at the node 402c-3 is negative (−1), and the result at the node 402c-4 is immaterial given the affirmative result at the (earlier) node 402b-1 (0).

At block 625, the computing device 100 assigns and/or maps each possible outcome o to one PE 108 for the outcome evaluation operation. That is, the assigned and/or mapped PE 108 represents the possible outcome o and is configured to accumulate an outcome metric representing the possible outcome o. In particular, the outcome metric is accumulated based on the outcome vector for the possible outcome o and a result vector from the node comparison operation. For example, the outcome metric may be a dot product of the outcome vector with the result vector. Thus, the evaluation of each of the possible outcomes o is performed at a separate PE 108 in one or more of the banks 102 and/or rows 104 and may be computed in parallel.

Accordingly, at block 630, the computing device 100 is configured to load the coefficients for the outcome vectors into the associated memory cells 204 of the PEs 108. In some examples, each outcome vector may be loaded into the corresponding memory cell 204 for the PE 108 configured to evaluate the outcome vector. In other examples, the coefficients of the outcome vectors may be loaded into the memory cells 204 in a diagonalized and/or otherwise patterned manner to allow the performance of a GEMV as described above by rotating and/or rearranging the input vector components (i.e., the components of the result vector) and accumulating the results in the local register. That is, the computing device 100 may define an outcome matrix defined based on the outcome vectors. The coefficients of the outcome matrix may then be loaded into the memory cells 204 in such a manner that each PE 108 accumulates the dot product for its corresponding assigned outcome vector with the result vector.

Referring again to FIG. 7, the computing device 100 may assign, at block 625, each outcome o to one of the PEs 108. In the present example, the outcome o₀ is assigned to the PE 108-0, the outcome o₁ is assigned to the PE 108-1, the outcome o₂ is assigned to the PE 108-2, the outcome o₃ is assigned to the PE 108-3, the outcome o₄ is assigned to the PE 108-4, and the outcome o₅ is assigned to the PE 108-5.

Subsequently, at block 630, the computing device 100 may load the outcome vectors representing the outcomes o into the memory cells 204. In the present example, for simplicity, the outcome vector having coefficients c₀₀ through cₒ₄ representing the outcome o₀ is loaded into the memory cell 204-0, the outcome vector having components c₁₀ through c₁₄ representing the outcome o₁ is loaded into the memory cell 204-1, the outcome vector having components c₂₀ through c₂₄ representing the outcome o₂ is loaded into the memory cell 204-2, the outcome vector having components c₃₀ through c₃₄ representing the outcome o₃ is loaded into the memory cell 204-3, the outcome vector having components c₄₀ through c₄₄ representing the outcome o₄ is loaded into the memory cell 204-4, and the outcome vector having components c₅₀ through c₅₄ representing the outcome o₅ is loaded into the memory cell 204-5.

As noted above, in other examples, the coefficients of the outcome vectors for the outcomes o may be extracted from the outcome vectors and loaded into the memory cells 204 in a diagonalized (or otherwise suitably patterned) manner based on the predefined rearrangements of the components in the local registers of the PEs 108. In such examples, the coefficients of the outcome vectors are loaded into the memory cells 204 such that the outcome metric for the outcome o₀ is accumulated in the PE 108-0, the outcome metric for the outcome o₁ is accumulated in the PE 108-1, the outcome metric for the outcome o₂ is accumulated in the PE 108-2, the outcome metric for the outcome o₃ is accumulated in the PE 108-3, the outcome metric for the outcome o₄ is accumulated in the PE 108-4, and the outcome metric for the outcome o₅ is accumulated in the PE 108-5.

Returning again to FIG. 6, at block 635, the computing device 100 may be configured to load a depth value for each outcome into the associated memory cell 204 of the PE 108 assigned to accumulate the outcome metric for the outcome. In particular, each outcome is associated with a certain depth or number of levels, or number of nodes to be evaluated to reach the given outcome. For example, the outcomes o₀, o₁, o₂, and o₃ have depths of three—that is, there are three levels 410a, 410b, and 410c for which a node comparison is performed to reach the outcome. The outcomes o₄ and o₅ have depths of two—that is, there are two levels 410a and 410b for which a node comparison is performed to reach the outcome.

The depth of each outcome therefore represents the number of nodes 402 which are evaluated to reach the outcome. Accordingly, during the outcome selection operation, the number of matching node comparison results may differ for different nodes, and therefore the depth of each outcome affects the outcome selection operation. Since the depths may be different for different outcomes, the computing device 100 loads a depth value for each outcome into the associated memory cell 204 of the PE configured to accumulate the outcome metric for the given outcome.

In some examples, the depth value may directly correspond to the depth for the outcome. In other examples, to simplify the outcome selection operation, the depth value may correspond to the depth minus one, or another suitable predefined formulaic relationship to the depth.

At block 640, the computing device 100 may be configured to load an outcome identifier for each outcome into the associated memory cell 204 of the PE 108 assigned to accumulate the outcome metric for the outcome. In particular, the outcome identifier may preferably be a numeric identifier to uniquely identify each of the outcomes during the outcome selection operation, as will be described in further detail herein.

For example, referring again to FIG. 7, the computing device 100 may load the depth value dv₀ and the outcome identifier z₀ into the memory cell 204-0, the depth value dv₁ and the outcome identifier z₁ into the memory cell 204-1, the depth value dv₂ and the outcome identifier z₂ into the memory cell 204-2, the depth value dv₃ and the outcome identifier z₃ into the memory cell 204-3, the depth value dv₄ and the outcome identifier z₄ into the memory cell 204-4, the depth value dv₃ and the outcome identifier z₅ into the memory cell 204-5.

Returning now to FIG. 5, after completing initialization of the PEs 108 to evaluate the decision tree 400, at block 510, the computing device 100 obtains an input vector, such as the input vector 404, to be processed by the decision tree 400. The input vector 404 includes the input attributes (i.e., the specific values for a given person, organization, case, etc. for the respective features) to be evaluated at each of the nodes 402. The input vector 404 may be loaded into the PEs 108 (or a subset of the PEs 108), for example in the local register 302 of the PEs 108. In particular, the computing device 100 may determine, for each given input attribute i, the corresponding node 402 configured to evaluate the given input attribute and load the given input attribute i into the local register 302 of the PE 108 assigned to the corresponding node 402. Thus, each input attribute of the input vector 404 may be loaded into a separate PE 108.

For example, the sorting layer 206 may be configured to sort the input attributes of the input vector 404 according to the nodes 402 assigned to a given set of PEs 108 (e.g., in a bank 102 or a row 104), and in particular, each input attribute to the particular node 402 configured to evaluate the input attribute. Preferably, the input vector 404 may be structured according to the order of nodes 402 identified at block 605 of the method 600 to facilitate loading the input vector 404 to the PEs 108. In other examples, other manners of sorting the input attributes of the input vector 404 are also contemplated, for example by using a “one-hot” matrix of coefficients, in which each PE 108 in the sorting layer 206 would include a single “1” coefficient for a given target feature to sort through a set of features to create the input vector 404.

At block 515, the computing device 100 is configured to perform the node comparison operation, in which the PEs 108 process the input vector to obtain a result vector. In particular, each PE 108 may compare the respective input attribute stored in the local register 302 to the threshold value stored at the predefined address in the associated memory cell 204. Since the input attributes and threshold values are loaded into the local registers 302 and memory cells 204 based on the node 402 assigned to a given PE 108, each PE 108 is configured to perform the comparison at the corresponding node 402. Further, the computing device 100 controls the PEs 108 to evaluate (i.e., to perform the assigned comparison of the input attribute to the threshold) each of the nodes 402 in the decision tree 400 in parallel, irrespective of the level 410 of the node 402 or the results of earlier nodes 402 in earlier levels 410.

Thus, the node comparison operation at block 515 represents a first phase of processing the input vector 404. As a result of the node comparison operation at block 515, the computing device 100 obtains a result vector representing the results at each of the nodes 402 of the decision tree 400. That is, the result vector is composed of the respective result of the node comparison operation obtained at each PE 108.

Additionally at block 515, the computing device 100 may store the result vector. In some examples, the computing device 100 may store result vector of the node comparison operation by replacing each of the input attributes for a given node 402 with the result for that node (i.e., the result of the comparison of the input attribute i with the corresponding threshold t) in the local register 302. For example, an affirmative result may be stored as a value of 1, while a negative result may be stored as a value of −1.

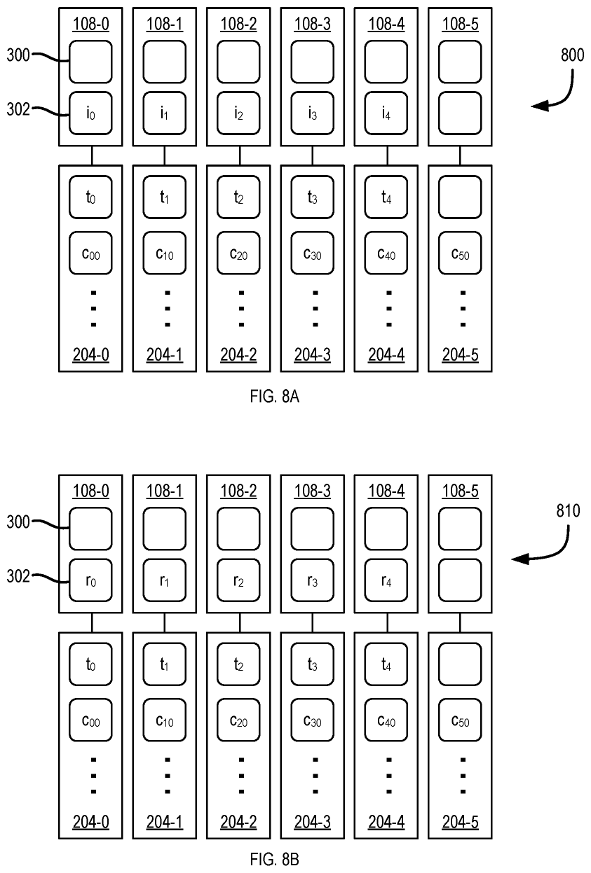

For example, referring to FIG. 8A, a partial representation of the array of PEs 108 in states 800 after obtaining the input vector 404 is depicted. In particular, after obtaining the input vector 404, the local registers 302 are loaded with the input attributes i corresponding with the node-PE assignment. FIG. 8B depicts the array of PEs 108 in a state 810 after completion of the node comparison operation, for example as described at block 515. Specifically, the computing device 100 completes the node comparison operation to compare the value of the input attribute i stored in the local register 302 with the corresponding threshold t stored at the predetermined memory address in the memory cell 204. After completing the node comparison operation, each PE 108 may replace the input attribute i in the local register 302 with the result r of the comparison. In particular, the PE 108 may update the local register 302 with a value of 1 if the input attribute i exceeds the threshold t, and a value of −1 if the input attribute i does not exceed the threshold t.

Returning again to FIG. 5, at block 520, the computing device 100 is configured to perform the outcome evaluation operation. In particular, each PE 108 is configured to accumulate the result vector from the node comparison operation with a respective outcome vector to obtain a respective outcome metric for the outcome assigned to the PE 108. The outcome metric may be a dot product of the result vector and the respective outcome vector. In particular, the coefficients of the outcome vectors are loaded into the memory cells 204 to allow the computing device 100 to perform a GEMV including multiple iterations of multiplications, accumulations and rotations to allow each PE 108 to accumulate the dot product of the result vector with the outcome vector for the outcome assigned to the PE 108 (i.e., the outcome metric for the outcome assigned to the PE 108). Accordingly, the accumulations of the respective outcome metrics at each of the PEs 108 may be performed in parallel, and the outcome metrics for each of the outcomes may be subsequently assessed in parallel, irrespective of the specific results at any individual node 402.

Each PE 108 may be configured to store the accumulations, including the intermediate accumulations during performance of the GEMV, in the local register 300. Accordingly, upon completion of the GEMV and the outcome evaluation operation, the local registers 300 of the PEs 108 may store the resultant outcome metrics for the respective outcomes assigned to the PEs 108.

At block 525, the computing device 100 is configured to identify or select one of the potential outcomes as the determined outcome of the decision tree for the input vector based on the respective outcome metrics of the potential outcomes. That is, the computing device 100 is configured to analyze the outcome metrics obtained at block 520 from the outcome evaluation operation to select one of the potential outcomes as the determined outcome. For example, the determined outcome may be identified as the potential outcome having the largest outcome metric, the outcome metric having a specific predetermined value, or the computing device 100 may apply further manipulations or other suitable assessments of the outcome metrics, based for example on the manner in which the coefficients of the outcome vectors and the result vectors are assigned.

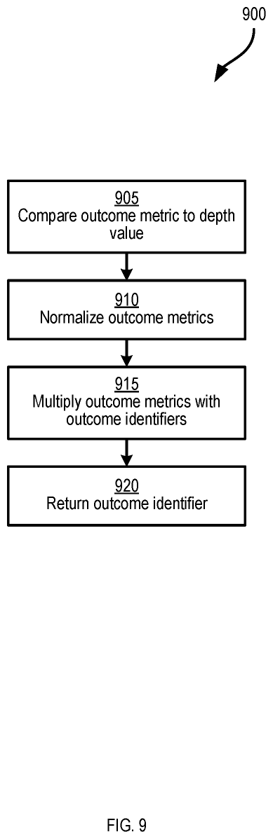

For example, FIG. 9 depicts an example method 900 of assessing the outcome metrics to select one of the potential outcomes as the determined outcome.

At block 905, the computing device 100 may be configured to compare the outcome metric for each outcome to the corresponding depth value stored in the associated memory cell 204 of the PE 108 assigned to accumulate the outcome metric.

In particular, in the present example, the outcome metrics are computed as dot products between an outcome vector for a given outcome and the result vector. Both the outcome vector and the result vector are represented by coefficients with a value of 1 for an affirmative result at a given node, and a value of −1 for a negative result at a given node. Additionally, the outcome vector includes coefficients with a value of 0 for nodes whose results are irrelevant for the given outcome.

Accordingly, when the results at a given node match (i.e., are either both 1 or are both−1), then the product of the outcome coefficient and the result coefficient is positive and provides a positive contribution to the outcome metric. When the results at a given node do not match (i.e., one has a value of 1 and the other a value of −1, or the node is irrelevant with a value of 0), then the product of the outcome coefficient and the result coefficient is zero or negative and provides no contribution or a negative contribution to the outcome metric.

Specifically, in order to reach a given outcome (i.e., the true outcome), the result vector will match the outcome vector at each level 410 in the decision tree, and accordingly, the outcome should have a resulting outcome metric equal to the depth associated with the outcome. Accordingly, in some examples, at block 905, the computing device 100 may compare the outcome metric directly to the depth stored as the depth value.

In other examples, to perform the comparison of the outcome metric to the depth value, the computing device 100 may subtract the stored depth value from the outcome metric. In the case where the depth value is equal to the depth for the respective outcome, the result of the subtraction is zero for the true outcome, and a negative value for the other outcomes. In the case where the depth value is equal to the depth less one for the respective outcome, the result of the subtraction is one for the true outcome and zero or a negative value for the other outcomes.

At block 910, the computing device 100 is configured to normalize the outcome metric. For example, the computing device 100 may store the result of the comparison at block 905, for example as an updated outcome metric. In particular, the computing device 100 may be configured to store the result of the comparison in the local register 300, replacing the previously computed outcome metric. For example, the computing device 100 may store the result of the subtraction performed as the comparison, or may conditionally store a value of one if the outcome metric is equal to the depth, and a value of zero if the outcome metric is not equal to the depth.

In some examples, at block 910, the computing device 100 may additionally normalize the result of the comparison. For example, where the comparison is a subtraction, the computing device 100 may perform a rectified linear unit (RELU) to set negative results to zero. This may be particularly useful when the depth value is assigned to be the depth less one for the respective outcome, such that the result of the subtraction is one for the true outcome and is normalized to zero for the other outcomes.

At block 915, the computing device 100 is configured to multiply the updated outcome by the outcome identifier for each outcome stored in the memory cell 204 associated with the PE 108 for the outcome. The result of the multiplication may similarly be stored as a further updated outcome metric. In particular, the true outcome is preferably the only outcome having an updated outcome metric of one, while the other outcomes are preferably set to zero. Thus, after the performance of block 915, the true outcome may remain the sole outcome having a non-zero updated outcome metric stored in the local register 300 of the PE 108 assigned to the outcome. Specifically, the updated outcome metric may be equal to the value of the outcome identifier for the true outcome.

At block 920, the computing device 100 returns the outcome identifier to identify the determined outcome of the decision tree 400 for the input vector 404. For example, the computing device 100 may determine the largest or maximum value stored in the local registers 300 of the PEs 108, and return that value as the outcome identifier for the determined outcome. In other examples, the computing device 100 may sum the values stored in the local registers 300 of the PEs 108 and may return the sum as the outcome identifier for the determined outcome.

Accordingly, as described herein, a computing device and method are provided to allow processing of a decision tree on an input vector with parallel processing. In a first phase, each of the attributes of the input vector is evaluated, representing the evaluation at each of the nodes of the decision tree. In particular, in the first phase, each node and attribute is processed, irrespective of the level of the node or results from earlier levels, thereby bypassing the natural hierarchy of the decision tree. In a second phase, the result vector is accumulated with a plurality of outcome vectors, each outcome vector representing one potential outcome of the decision tree. The potential outcomes are then represented by the outcome metrics (i.e., the results of the accumulations). Similarly, in the second phase, each potential outcome is compared with the result vector, irrespective of results from any of the individual nodes, similarly bypassing the natural hierarchy of the decision tree. The outcome metrics may then be assessed or analyzed to identify one of the potential outcomes as the determined or true outcome for the application of the decision tree on the input vector.

The scope of the claims should not be limited by the embodiments set forth in the above examples but should be given the broadest interpretation consistent with the description as a whole.

1. A computing device comprising:
a bank of processing elements;
a controller interconnected with the bank of processing elements, the controller configured to:
obtain an input vector having a plurality of input attributes, the input vector to be processed by a decision tree to identify a determined outcome for the input vector;
control the bank of processing elements to process the input vector to obtain a result vector, wherein each input attribute is processed by one of the processing elements in the bank to obtain a result, and wherein the result vector comprises a combination of the results;
control the bank of processing elements to accumulate the result vector with an outcome vector for each potential outcome of the decision tree to obtain a respective outcome metric for each potential outcome; and
select one potential outcome as the determined outcome of the decision tree for the input vector based on the respective outcome metrics for each potential outcome.

2. The computing device of claim 1, wherein the decision tree comprises a plurality of nodes, each node configured to process a given input attribute of the input vector.

3. The computing device of claim 2, wherein the controller is further configured to: assign each node of the decision tree to one of the processing elements to process the given input attribute to obtain the result.

4. The computing device of claim 1, wherein to process the input attribute, the processing element is configured to compare the input attribute to a predefined threshold for the input attribute.

5. The computing device of claim 4, wherein the controller is further configured to initialize the bank of processing elements to store the predefined threshold for each input attribute in a respective corresponding memory cell of the processing element.

6. The computing device of claim 1, wherein the controller is configured to assign each respective outcome metric to be accumulated by one of the processing elements in the bank.

7. The computing device of claim 1, wherein the respective outcome metric comprises a dot product between the result vector and the respective outcome vector.

8. The computing device of claim 7, wherein the controller is configured to apply a generalized matrix-vector multiply between the result vector and an outcome matrix comprising the outcome vectors to accumulate the respective outcome metrics.

9. The computing device of claim 8, wherein the controller is configured to initialize the bank of processing elements to load the outcome matrix into memory cells associated with the processing elements.

10. The computing device of claim 1, wherein to select the determined outcome, the controller is configured to:
compare each outcome metric to a depth value for the potential outcome; and
normalize the outcome metrics;
multiply each normalized outcome metric by a respective outcome identifier; and
return the outcome identifier identifying the determined outcome.

11. A method comprising:
obtaining an input vector having a plurality of input attributes, the input vector to be processed by a decision tree to identify a determined outcome for the input vector;
controlling a bank of processing elements to process the input vector to obtain a result vector, wherein each input attribute is processed by one of the processing elements in the bank to obtain a result, and wherein the result vector comprises a combination of the results;
controlling the bank of processing elements to accumulate the result vector with an outcome vector for each potential outcome of the decision tree to obtain a respective outcome metric for each potential outcome; and
selecting one potential outcome as the determined outcome of the decision tree for the input vector based on the respective outcome metrics for each potential outcome.

12. The method of claim 11, wherein the decision tree comprises a plurality of nodes, each node configured to process a given input attribute of the input vector.

13. The method of claim 12, further comprising: assigning each node of the decision tree to one of the processing elements to process the given input attribute to obtain the result.

14. The method of claim 11, wherein processing the input attribute comprises comparing the input attribute to a predefined threshold for the input attribute.

15. The method of claim 14, further comprising initializing the bank of processing elements to store the predefined threshold for each input attribute in a respective corresponding memory cell of the processing element.

16. The method of claim 11, further comprising assigning each respective outcome metric to be accumulated by one of the processing elements in the bank.

17. The method of claim 11, wherein the respective outcome metric comprises a dot product between the result vector and the respective outcome vector.

18. The method of claim 17, further comprising applying a generalized matrix-vector multiply between the result vector and an outcome matrix comprising the outcome vectors to accumulate the respective outcome metrics.

19. The method of claim 18, further comprising initializing the bank of processing elements to load the outcome matrix into memory cells associated with the processing elements.

20. The method of claim 11, wherein selecting the determined outcome comprises:
comparing each outcome metric to a depth value for the potential outcome; and
normalizing the outcome metrics;
multiplying each normalized outcome metric by a respective outcome identifier; and
returning the outcome identifier identifying the determined outcome.
